(19) United States
(12) Patent Application Publication
(10) Pub. No.: US 2005/0116424 A1
(43) Pub. Date: Jun. 2, 2005

(54) Self positioning astragal seal

(76) Inventor: Vernard W. Sanders, Oxnard, CA (US)

Correspondence Address: Marvin E. Jacobs;KOPPEL & JACOBS, Suite 215, 2151 Alessandro Drive, Ventura, CA, 93001, US

(21) Appl. No.: 10/763,091

(22) Filed: Jan. 21, 2004

Related U.S. Application Data
(60) Provisional application No. 60/441,797, filed on Jan. 21, 2003.

(51) Int. Cl. F16J 15/34

(52) U.S. Cl. 277/377

(57) ABSTRACT

A self positioning astragal seal that automatically positions at least one seal at the lower end of an astragal adjacent the threshold sill of a door frame, and prevents drafts at the vicinity of the lower end of the astragal and the threshold sill, and/or of automatically positions at least one seal at the upper end of the astragal adjacent the header of the door frame, and prevent drafts at the vicinity of the header. The self positioning astragal seal independently positions itself abuttingly adjacent the sill and/or the header when the astragal's bolts are extended from a retracted position to an extended position and are received by the upper and/or lower apertures in the upper and/or lower portions of the door frame, is easy to use, install, and can be used with a variety of astragals and threshold sills, types, sizes, and shapes of threshold sills, doors, and door frames.

### BACKGROUND OF THE INVENTION

1. Field of the Invention

The present invention relates generally to astragal seals and more particularly to self positioning astragal seals.

2. Background Art

Double entrance doorways are used in a large variety of residential homes and commercial buildings. Typically, an active door provides for day to day ingress and egress to and from the residential home or building, and an inactive door remains closed, except in instances when a width greater than or equal to the width of the active door and less than or equal to the width of the double entrance doorway is required, such as, for example, for delivery of furniture and/or equipment that cannot fit through the double entrance doorway. If large objects, such as furniture and/or equipment must pass through the double entrance doorway, both the normally inactive door and the active door of the doorway are opened, to create a wide entrance way, through which the furniture and/or equipment may pass.

Mating edges of the inactive door and the active door do not typically contact one another directly, but are separated by an astragal, the astragal being attached to the edge of an inactive leaf, the astragal extending the length of the inactive door, cushioning the closing of the active door and associated inactive leaf of the doorway, and sealing gaps between the inactive door and the active door.

The astragals often have upper and lower bolt-slide assemblies, which lock the astragals and the inactive doors to upper and lower portions of a door frame surrounding the double entrance door way. The upper and lower bolt-slide assemblies have bolts, which slide within upper and lower ends of the astragal, and are pushed outwardly from the inactive door to extend beyond the ends of the astragal, and are received by upper and lower apertures in the upper and lower portions of the door frame, also known as the header and threshold sill, respectively, to lock the inactive door in place.

Stationary seals are typically used at the lower end of the astragals for sealing and preventing drafts from entering the residential homes and/or commercial buildings through the double entrance doorways at the threshold sill. Since many different types, sizes, and shapes of thresholds are used, the drafts remain an unwanted by product of using the stationary sills. In many instances, the fixed size of the seals, and the materials used, for the stationary seals, are either too thick or too thin to fill the gap between the lower end of the astragal and the threshold sill, and, thus, result in not providing an adequate seal, and/or the seal degrading over time.

There is thus a need for a self positioning astragal seal that prevents unwanted drafts, is easy to use and install in a quick, convenient, and efficient manner, is durable and long lasting, maintains its seal against drafts over time, even in situations where repeated opening and closing of the inactive door is necessary, and can be used with a variety of astragals and threshold sills, types, sizes, and shapes of threshold sills, doors, and door frames.

The self positioning astragal seal should be capable of automatically positioning at least one seal at the lower end of the astragal adjacent the threshold sill, and prevent drafts at the vicinity of the lower end of the astragal and the threshold sill, and/or of automatically positioning at least one seal at the upper end of the astragal adjacent the header, and prevent drafts at the vicinity of the header.

The self positioning astragal seal should independently position itself abuttingly adjacent the sill and/or the header when the bolts are extended from a retracted position to an extended position and are received by the upper and/or lower apertures in the upper and/or lower portions of the door frame.

Different astragals have heretofore been known. However, none of the astragals adequately satisfies these aforementioned needs. U.S. Pat. No. 5,857,291 (Headrick) discloses an astragal with integral sealing lock block, for use with a double door installation, which includes an astragal strip secured along a vertical edge of an inactive door. A lock block is slidably disposed in at least one end of the astragal strip, and can be moved between an extended position, for securing the inactive door, and a retracted position for freeing the inactive door. The lock block has a projecting bolt receivable in a receptacle in a door frame, when the lock block is slid to its extended position. A gasket is secured to an end of the lock block, and the bolt passes through an opening in the gasket. The gasket engages and seals against the door frame, when the lock block is in its extended position. Gaskets are also provided on the sides of the lock block, for engaging and sealing against the doors of the double door installation. When the doors are closed and secured in place, the lock block and gasket assembly prevents drafts from flowing under the door installation beneath the astragal thereof.

U.S. Pat. Nos. 5,350,207 and 5,328,217 (Sanders) disclose locking astragals, for attaching to an inactive leaf of a double doorway, and in particular U.S. Pat. No. 5,350,207. Each of the locking astragals has an elongated astragal casing, which has a channel and bolt-slide assemblies mounted slidably within the channel. Each bolt-slide assembly includes a latching member and bolt. By depressing the latching member, the latching member can slide through the channel, to extend and lock the bolts into indentations in upper and lower surfaces of a door frame. The bolts may also be retracted back into the astragal, to open the inactive leaf. Each of the latching members has an integral spring, which simplifies fabrication and assembly.

U.S. Pat. No. 6,491,326 (Massey, et al) discloses a swing adaptable astragal with lockable unitary flush bolt assemblies, for double door entryways, which includes an extruded aluminum frame into which upper and lower flush bolt assemblies are slidably disposed. The flush bolt assemblies include a long metal bolt about which is injection overmolded a series of retainer guides, which ride in the frame. Locking mechanisms are also integrally overmolded onto the bolts. The frame and all components of the astragal assembly are symmetrical and reversible, so that the assembly is non-handed; that is, it can be adapted to both a right hand swing and a left-hand swing inactive door. A strike plate mounting system and bottom-sealing block are provided, and the upper end of the assembly includes means for sealing against a stop of a head jamb. Drafts at upper and lower inside corners of the doors of a double door entryway may be prevented.

U.S. Pat. No. 6,125,584 (Sanders) discloses an automatic door bottom for a hinged door, which is pivotable to be positioned over a sill when closed, the door having a hinge side and a width, the door bottom having an inverted channel having an open bottom, a length corresponding to the door width and a hinge end corresponding to the hinge side of the door; a sealing member having a length corresponding to the length of the channel, the sealing member being housed in the channel and being movable vertically downwardly into a sealing position, in which the sealing member contacts the sill when the door is closed; and a displacement mechanism installed in the channel and coupled to the sealing member, for moving the sealing member vertically into the sealing position in response to closing of the door, wherein the displacement mechanism is coupled to the sealing member at a plurality of points along the length of the sealing member, and is operative to move the end of the sealing member at the hinge side of the channel into the sealing position, prior to the remainder of the sealing member, during closing of the door.

U.S. Pat. No. 6,457,751 (Hartman) discloses a locking assembly for an astragal, which can be attached to an inactive door of a double door unit of a residence or a building. The astragal is attached to an edge of the inactive door in space between the inactive door and active door. A separate locking assembly is attached adjacent a top end of the door and also adjacent a bottom end of the door. A plug having an elongated locking bolt extending therefrom is mounted in a front end of a carriage member. Additional structure is provided for reciprocal travel of the carriage member between a locked position and an unlocked position.

U.S. Pat. No. 5,335,450 (Procton) discloses an astragal, which has an exterior aluminum extrusion and an interior wooden portion. The exterior extrusion includes a pair of rearwardly extending center walls, which form a channel for receiving the wooden interior portion. Attachments and door hardware can be installed in the wooden interior portion, while the extruded exterior acts as cladding.

U.S. Pat. No. 5,590,919 (Germano) discloses a T-astragal and sleeve for door, for use with double swinging doors, such as for french doors. The T-astragal includes a cap portion perpendicular to a base portion, wherein both the cap and base can be formed from wood, such as plywood or plastic. The T-astragal is a molding that extends the full height of the swinging doors. One side of the base portion is fixably coupled to the free end of one of the swinging doors by nails or screws. The free end of the other swinging doors is able to swing up to and against a shoulder portion formed from the cap and base portions. A metal pipe shaped sleeve having an approximate length of one foot is partially positioned along the longitudinal axis of the T-astragal molding. A bolt slides within the sleeve from a rest position to an extended position, where the extended position locks the attached door to a matching slot in the door frame.

U.S. Pat. No. 4,429,493 (St. Aubin) discloses an astragal housing seal and lock, for use in a double door assembly having an active door and a relatively inactive door. The astragal has a vertically extending mullion housing, which is attached to a free edge of the relatively inactive door. A vertically extending slide section is mounted on the mullion housing on a sealing side of the free edge of the inactive door. The slide section extends from the free vertical edge of the inactive door, when the active door is in the closed position. The slide section is vertically movable from an unlocked position to a locked position, wherein the slide section is moved vertically downward, with respect to the mullion housing, to engage the sill/threshold of the door frame, thereby preventing movement of the inactive door.

U.S. Pat. No. 4,058,332 (DiFazio) discloses an astragal and flush bolt assembly to be secured to a relatively stationary member such as a door jamb or to the edge of an inactive door of a pair of double doors or the like. The astragal assembly includes a flat metal body mounted on the edge of the stationary member and a metal stop member secured to the body along one edge thereof. The flat body includes first and second spaced apart legs extending outwardly from the stationary member, with the flat body and legs defining a channel to receive and retain a door latch bolt from the active door. The stop member prevents movement of the door in a first direction, and when the latch bolt is engaged in the channel, the channel and latch bolt prevent the door from moving in the opposite direction. A pair of flush bolts are slidably mounted in the channel, one adjacent each end thereof, so that when the astragal assembly is utilized with double doors, the flush bolts are moved to engage the header and sill, respectively, to hold the inactive door stationary. The astragal body is secured to the stop member by a thermal barrier or thermal break structure, to provide thermal insulation between the inside and the outside of the doors. The stop member also includes a weather strip to form a seal against the active door, and when metal doors or metal covered doors are used, the weather strip may include a magnetic member to form a seal against the active door.

U.S. Pat. No. 6,453,616 (Wright) discloses an astragal for use with exterior double door installations, such as french doors. When attached to the edge of a generally inactive door, the astragal provides a door stop for an active door, a seal to prevent intrusion of water, and a lock for the inactive door. The invention particularly pertains to extruded metal astragals, capable of increasing the resistance of the double door system to high wind conditions. The astragal comprises a longitudinally extending base member that has at least one longitudinally extending channel and a pair of spaced apart outwardly extending legs. At least one bolt is slidably inserted in the channel adjacent to one of the first and second ends of the channel. The astragal is attached to the door, by at least one cleat whose spaced apart arms engage the legs of the base member, providing resistance to the astragal rocking in relation to the door edge, when the doors are subject to wind forces.

U.S. Pat. No. D293,719 discloses a combined astragal extrusion and seal. For the foregoing reasons, there is a need for a self positioning astragal seal that prevents unwanted drafts, is easy to use and install in a quick, convenient, and efficient manner, is durable and long lasting, maintains its seal against drafts over time, even in situations where repeated opening and closing of the inactive door is necessary, and can be used with a variety of astragals and threshold sills, types, sizes, and shapes of threshold sills, doors, and door frames. The self positioning astragal seal should be capable of automatically positioning at least one seal at the lower end of the astragal adjacent the threshold sill, and prevent drafts at the vicinity of the lower end of the astragal and the threshold sill, and/or of automatically positioning at least one seal at the upper end of the astragal adjacent the header, and prevent drafts at the vicinity of the header. The self positioning astragal seal should independently position itself abuttingly adjacent the sill and/or the header when the bolts are extended from a retracted position to an extended position and are received by the upper and/or lower apertures in the upper and/or lower portions of the door frame.

### SUMMARY

The present invention is directed to a self positioning astragal seal that automatically positions at least one seal at the lower end of an astragal adjacent the threshold sill of a door frame, and prevent drafts at the vicinity of the lower end of the astragal and the threshold sill, and/or of automatically positions at least one seal at the upper end of the astragal adjacent the header of the door frame, and prevent drafts at the vicinity of the header. The self positioning astragal seal independently positions itself abuttingly adjacent the sill and/or the header when the astragal's bolts are extended from a retracted position to an extended position and are received by the upper and/or lower apertures in the upper and/or lower portions of the door frame. The self positioning astragal seal prevents unwanted drafts, is easy to use and install in a quick, convenient, and efficient manner, is durable and long lasting, maintains its seal against drafts over time, even in situations where repeated opening and closing of the inactive door is necessary, and can be used with a variety of astragals and threshold sills, types, sizes, and shapes of threshold sills, doors, and door frames.

A self positioning astragal seal, for use with an astragal having a bolt having a bolt retracted position and a bolt extended position, having features of the present invention comprises: a seal block having a catch and a hole, the bolt slidably disposed through the hole, the catch catching a portion of the bolt and holding the seal block in a seal block retracted position when the bolt is in the bolt retracted position and releasing the seal block when the bolt is in the bolt extended position; spring means forcing the seal block into a seal block extended position when the seal block is released.

An astragal having a self positioning astragal seal having features of the present invention comprises: an astragal body; a bolt having a bolt retracted position and a bolt extended position; a seal block having a catch and a hole, the bolt slidably disposed through the hole, the catch catching a portion of the bolt and holding the seal block in a seal block retracted position when the bolt is in the bolt retracted position and releasing the seal block when the bolt is in the bolt extended position; spring means forcing the seal block into a seal block extended position when the seal block is released.

### DRAWINGS

These and other features, aspects, and advantages of the present invention will become better understood with regard to the following description, appended claims, and accompanying drawings where:

FIG. 1 is a perspective view of a self positioning astragal seal, constructed in accordance with the present invention, shown extended;

FIG. 2 is a perspective view of the self positioning astragal seal, shown retracted;

FIG. 3 is an exploded view of the self positioning astragal seal and a latching mechanism;

FIG. 4 is an exploded view of selected components of the self positioning astragal seal and a portion of the latching mechanism of FIG. 3;

FIG. 5 is an exploded view of the latching mechanism of FIG. 3;

FIG. 6 is a perspective view of entrance doors, comprising an inactive door, shown in a closed position, and an active door;

FIG. 7 is a perspective view of the inactive door, showing the self positioning astragal seal and an astragal installed thereon the inactive door, with the self positioning astragal seal extended;

FIG. 8 is a section view of the self positioning astragal seal, shown extended;

FIG. 9 is another section view of the self positioning astragal seal, shown extended;

FIG. 10 is another section view of the self positioning astragal seal, with the self positioning astragal seal extended;

FIG. 11 is another section view of the self positioning astragal seal, with the self positioning astragal seal extended;

FIG. 12 is another section view of the self positioning astragal seal, with the self positioning astragal seal extended;

FIG. 13 is another section view of the self positioning astragal seal, with the self positioning astragal seal extended;

FIG. 14 is another section view of the self positioning astragal seal, with the self positioning astragal seal extended;

FIG. 15 is a section view of the latching mechanism of FIG. 3, along a portion of line 8-8 of FIG. 7, with the self positioning astragal seal extended;

FIG. 16 is a section view of the self positioning astragal seal, along a portion of line 8-8 of FIG. 7, with the self positioning astragal seal extended;

FIG. 17 is a section view of the self positioning astragal seal, shown retracted;

FIG. 18 is another section view of the self positioning astragal seal, shown retracted;

FIG. 19 is an exploded view of an upper bolt and latching mechanism of the astragal of FIG. 7.

FIG. 20 is a section view of the self positioning astragal seal shown with an alternate embodiment of an astragal installed thereon the inactive door;

FIG. 21 is a section view of the self positioning astragal seal shown with an alternate embodiment of an astragal installed thereon the inactive door;

FIG. 22 is a section view of the self positioning astragal seal shown with an alternate embodiment of an astragal installed thereon the inactive door, and also showing the active door;

FIG. 23 is a section view of the self positioning astragal seal shown with an alternate embodiment of an astragal installed thereon the inactive door, and also showing the active door;

FIG. 24 is a section view of the self positioning astragal seal shown with an alternate embodiment of an astragal installed thereon the inactive door, and also showing the active door; and

FIG. 25 is a section view of the self positioning astragal seal shown with an alternate embodiment of an astragal installed thereon the inactive door, and also showing the active door.

### REFERENCE NUMERALS

These and other features, aspects, and advantages of the present invention will become better understood with regard to the references and associated reference numerals of the following description and accompanying drawings where:
10 self positioning astragal seal
12 seal block
14 seal block hole
16 shoulder
18 compression spring
20 end seal
30 astragal
42 inactive door edge
44 inactive door
46 sill
48 door frame
52 elongated guide
54 elongated guide channel
56 lower bolt
58 shoulder
60 astragal bottom
74 seal block bottom
78 seal block base
80 face plate
82 guide block
84 “T” shaped member
86 compression spring guide holder
88 compression spring bottom end
90 base top
92 barrel
94 barrel extension
96 barrel extension arcuate interior
98 extension
100 extension arcuate interior
102 T top portion
104 arcuate interior
105 angled edges
106 shoulder
108 face plate reinforcement
110 face plate stop
112 guide block edge stop
114 guide block reinforcement
116 guide block stop
130 astragal recess
132 astragal extension stop
134 astragal retraction stop
136 astragal opposing side
138 astragal side portion
140 astragal side
142 side channel
144 threaded hole
146 threaded hole
148 set screw
150 angled longitudinal channel edge
152 compression spring top end
154 seal hole
156 face seal
158 face plate exterior side
160 active door edge
162 active door
164 header
166 seal peel off adhesive strip
168 face seal peel off adhesive strip
180 astragal housing
182 longitudinal channel
184 longitudinal retention guide
185 channel base
186 lockset strike
188 deadbolt strike
190 upper bolt
191 upper bolt assembly
192 lockset
194 deadbolt
196 lockset cover plate
198 deadbolt cover plate
199 screws
200 latching member
202 pull block
204 elongated connector
206 compression spring
208 slide plate
210 bolt lower portion
212 bolt mid portion
214 bolt upper portion
216 bolt slot
218 bolt hole
220 end pin
222 elongated connector hole
224 pin
226 pin
228 pull block track
230 pull block retention track
232 pull block retention track
234 pull block channel
236 pull block channel
238 pull block notch
240 pull block base
242 pull block notch
244 pull block bearing notch
246 pull block notch side
248 lever arm receiving hole
250 lever arm
252 trunnion
254 spring tail
256 latching dog
260 slide plate retraction hole
262 slide plate extension hole
264 slide plate notch
266 slide plate end tab
268 slide plate projecting tab
270 slide plate projecting notch
280 elongated guide notched recess
282 elongated guide end
284 pull block arrow marking
286 arcuate side
288 arcuate base
300 alternate astragal housing
302 saw tooth recess
304 finned tail
306 foam weather strip
308 cavity
310 alternate astragal housing
312 thermal break
314 slot
320 alternate astragal
322 alternate astragal housing
324 cover
326 outer seal
328 inner seal
330 alternate astragal
332 thermal break
340 alternate astragal
342 cover element
344 saw tooth recess
346 finned tail
348 weather strip seal
349 inner seal
350 alternate astragal
352 thermal break

### DESCRIPTION

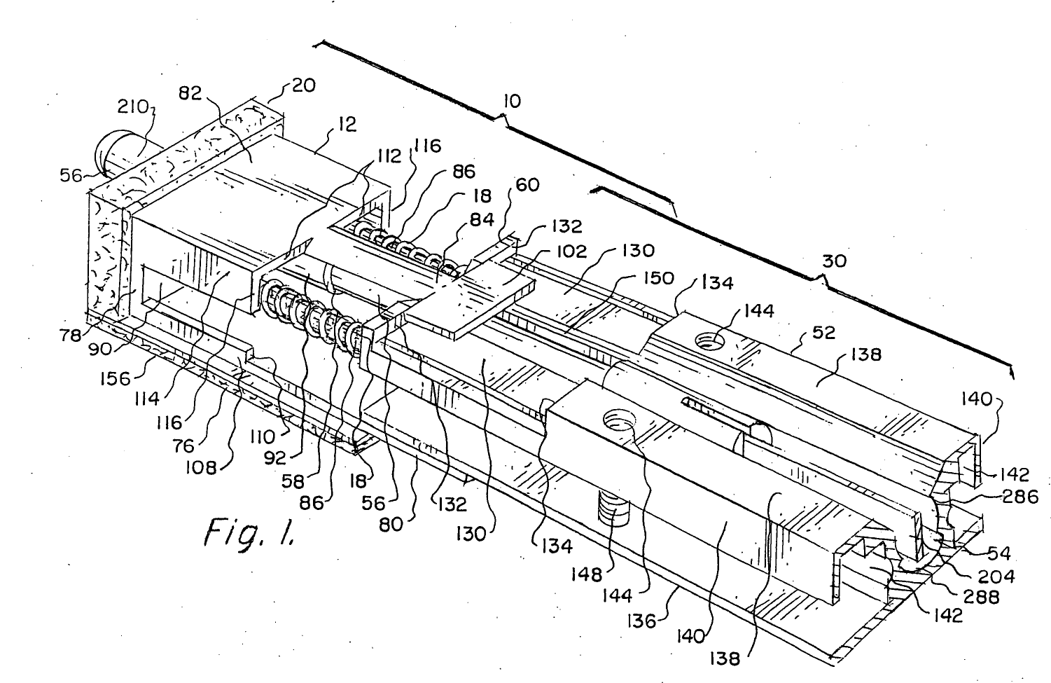

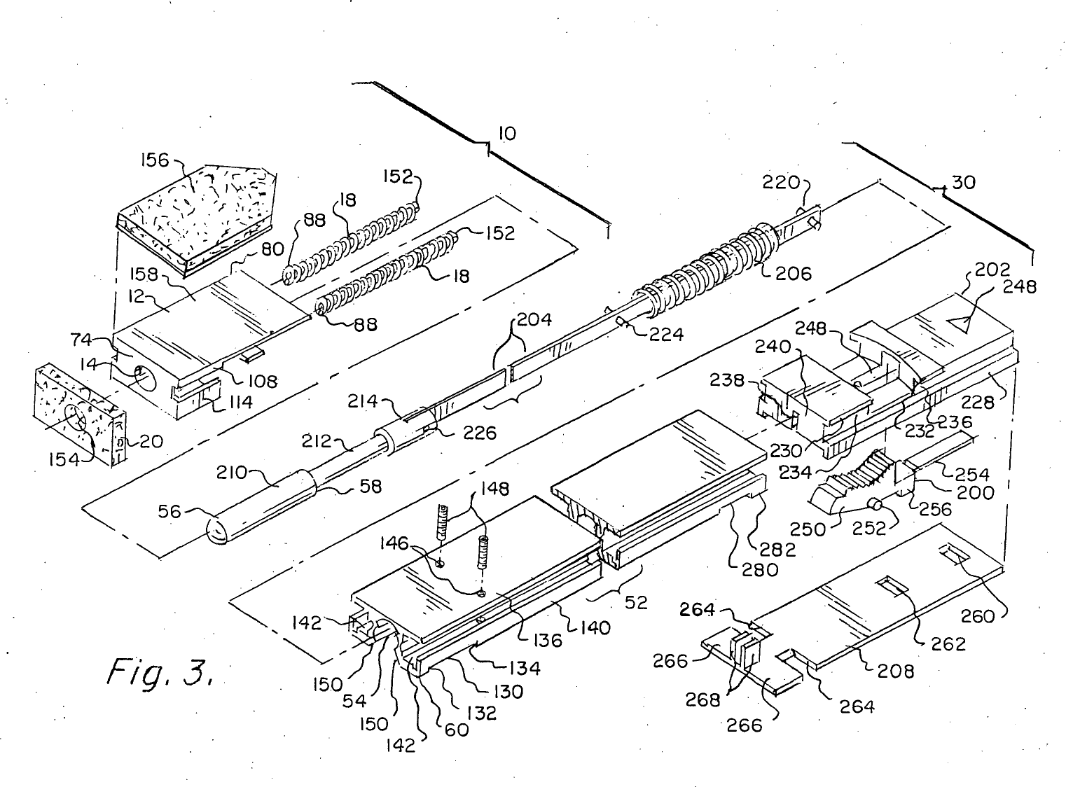

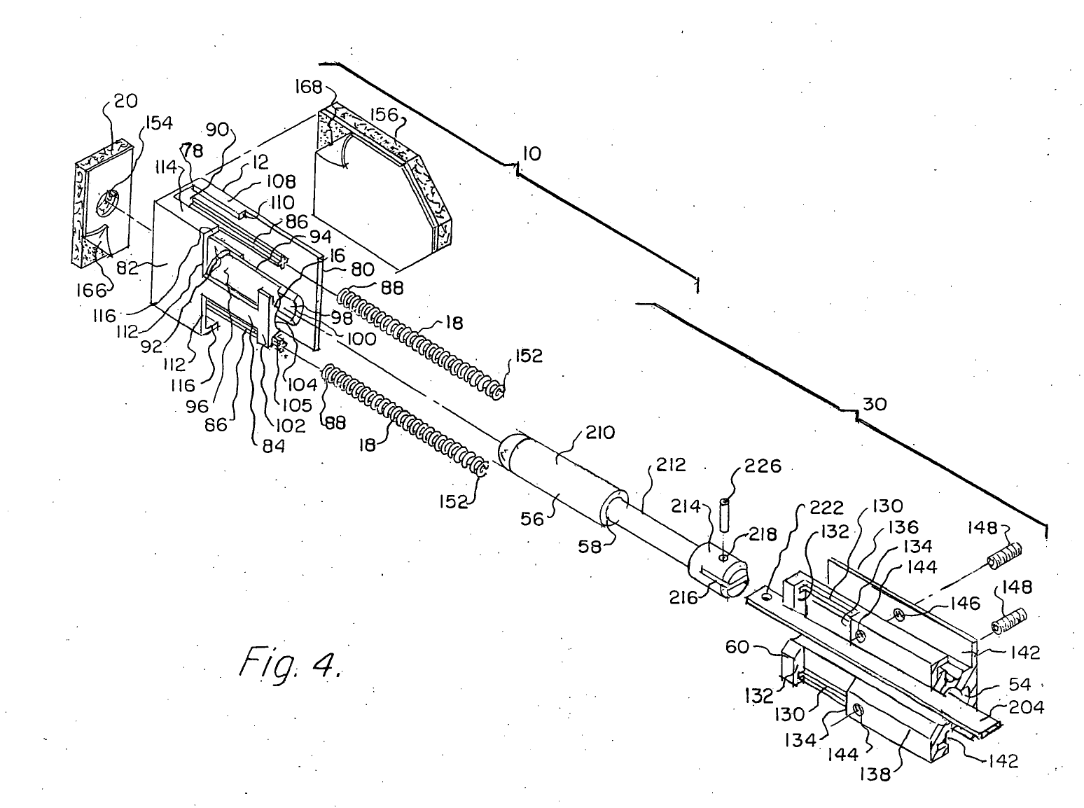

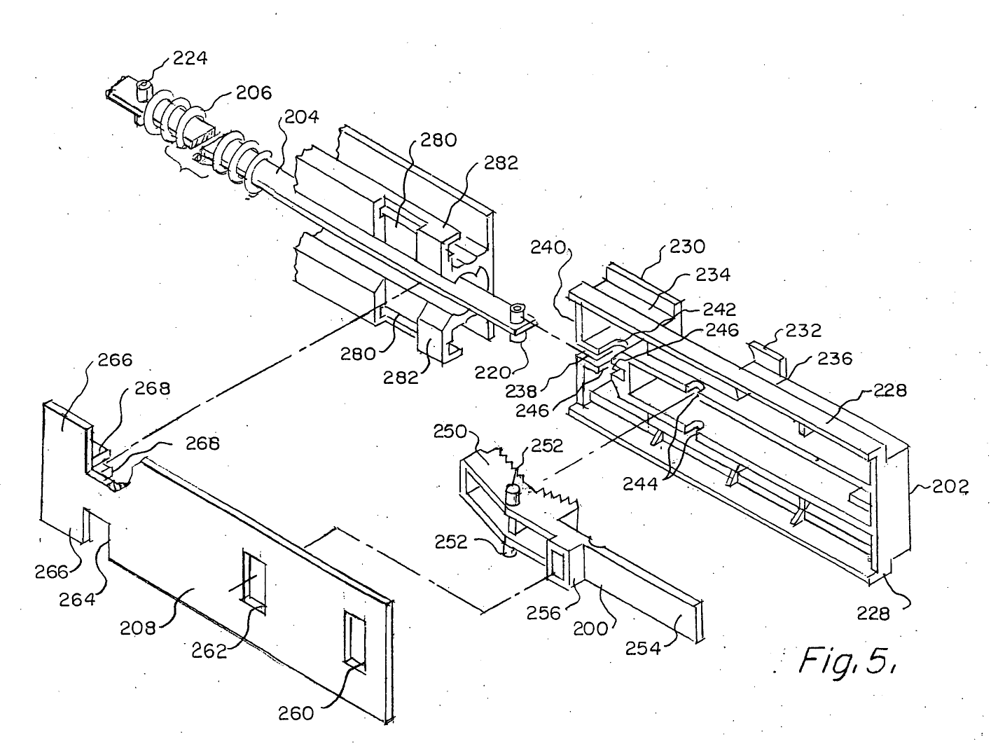

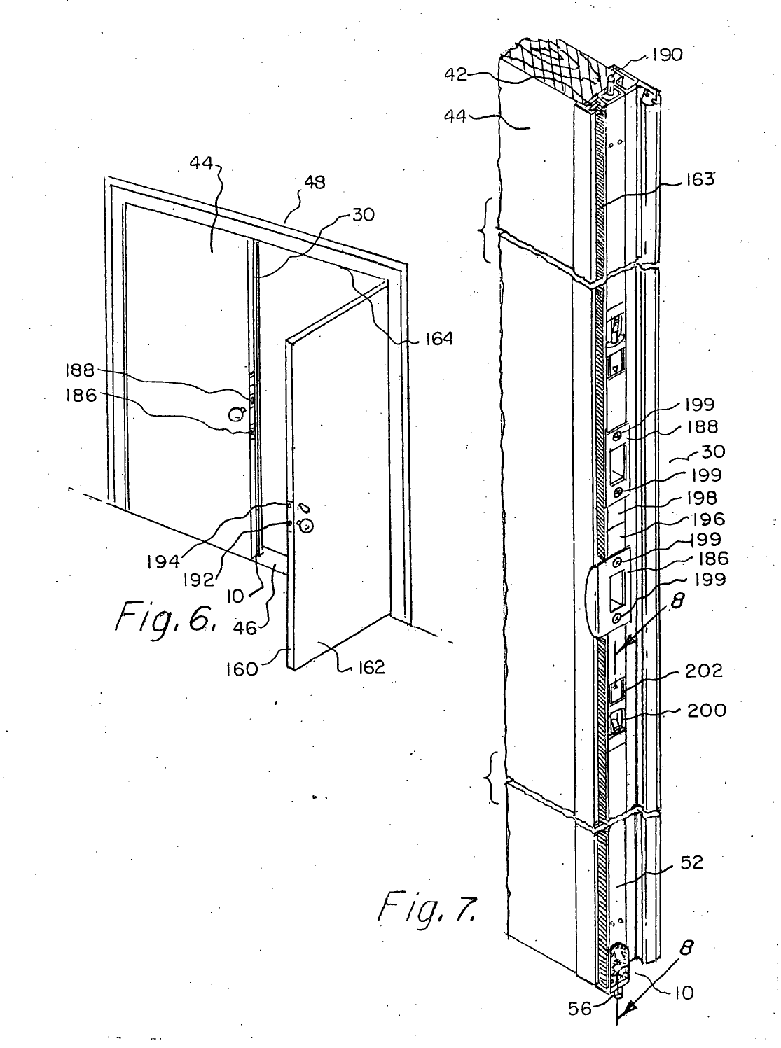

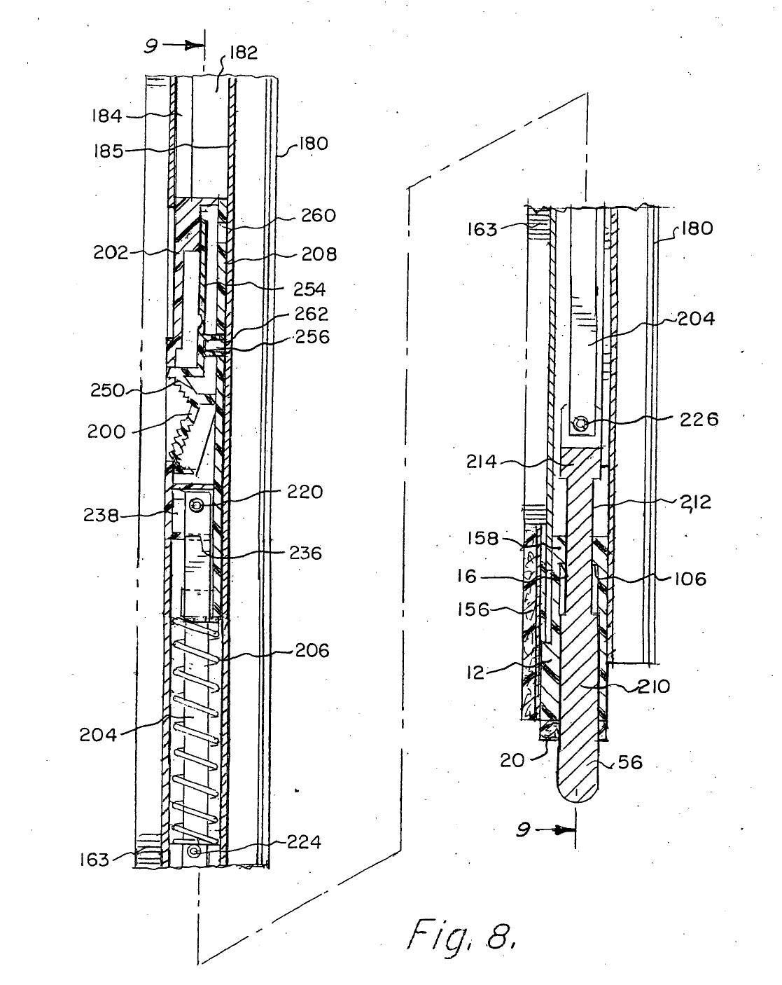

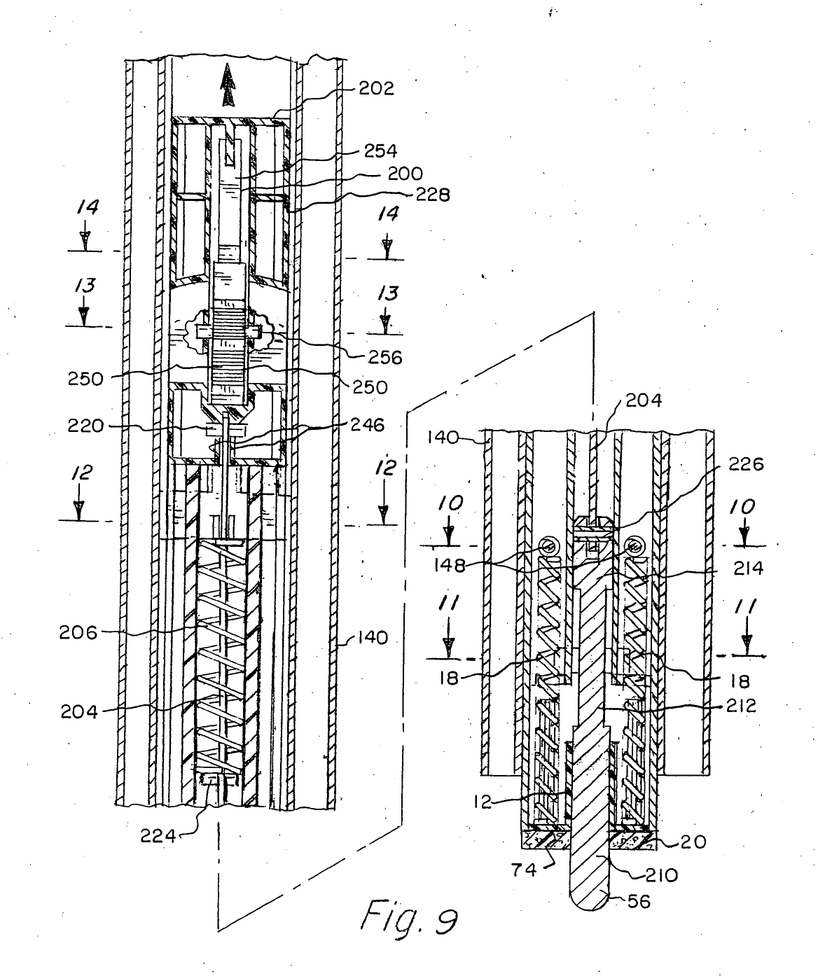

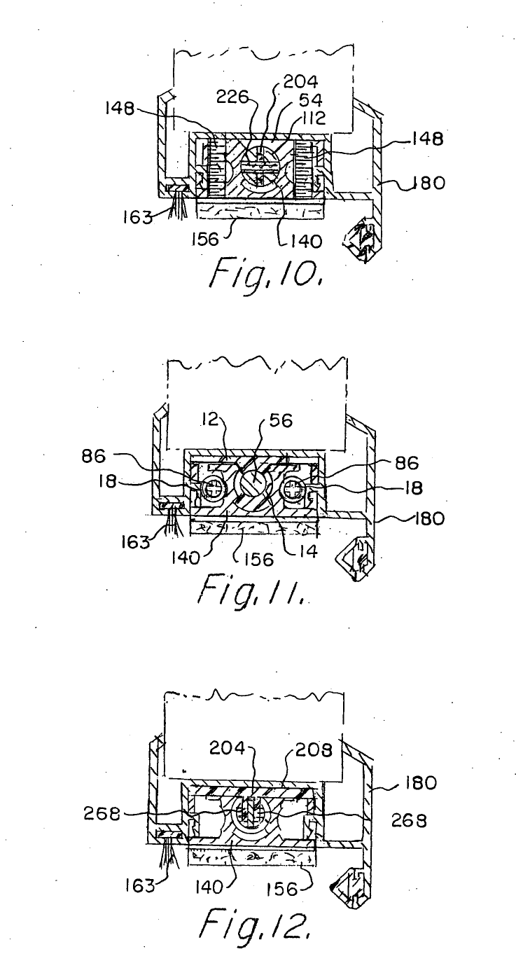

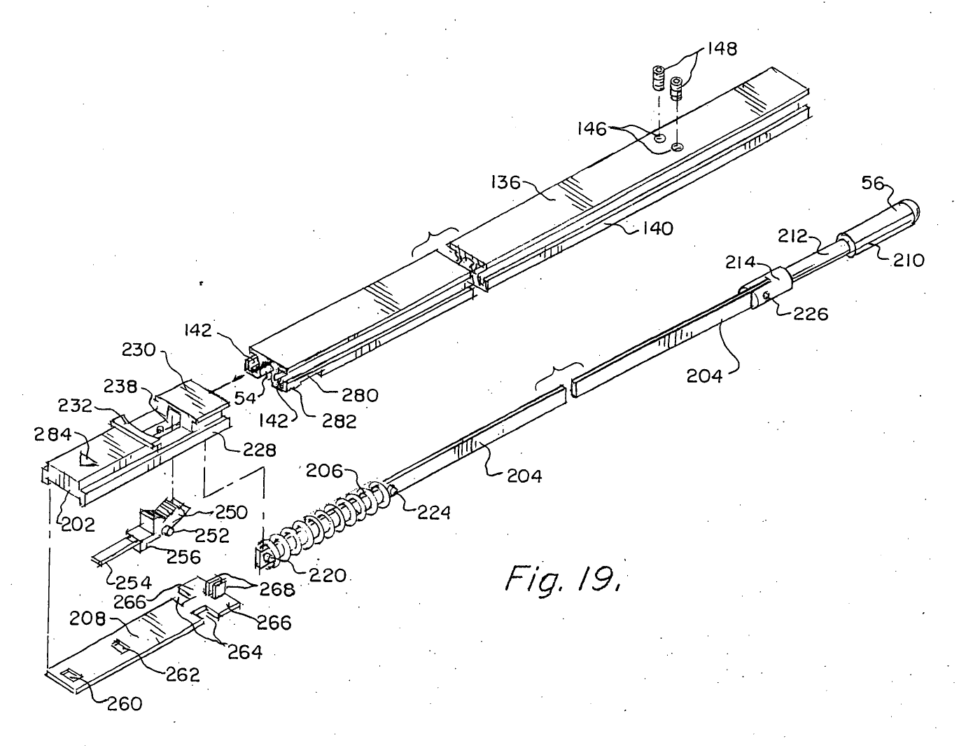

The preferred embodiments of the present invention will be described with reference to FIGS. 1-25 of the drawings. Identical elements in the various figures are identified with the same reference numbers.

FIGS. 1-19 show an embodiment of the present invention, a self positioning astragal seal 10, which comprises a seal block 12 having a substantially centrally disposed hole 14 therethrough, a shoulder 16, compression springs 18, and end seal 20, for use with an astragal 30.

The astragal 30 is mounted to edge 42 of inactive door 44, and the self positioning astragal seal 10 is mounted to the astragal 30 adjacent sill 46 of door frame 48, as shown in FIGS. 6 and 7. The astragal 30 has an elongated guide 52 having a substantially centrally disposed longitudinal channel 54 and a bolt 56 having a shoulder 58, the bolt 56 slidably mounted therein the substantially centrally disposed longitudinal channel 54.

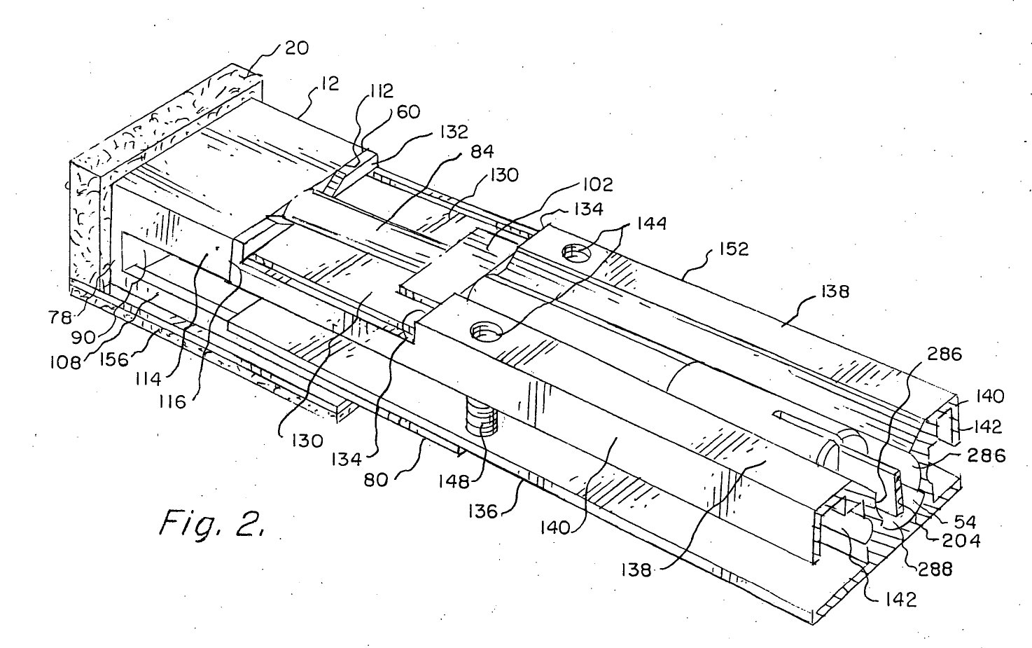

The astragal seal shoulder 16 catches the bolt shoulder 58 when the bolt 56 is retracted to a retracted position, as shown in FIGS. 2, 17, and 18, and is released from the bolt shoulder 58 when the bolt 56 is extended to an extended position, as shown in FIGS. 1 and 7-16, the compression springs 18 forcing the seal block 12 into an extended position, when the bolt 56 is in the bolt extended position. The seal block 12 is, thus, retracted to a retracted position, the astragal seal shoulder 16 catching and abutting the bolt shoulder 58, and holding the seal block 12 in a seal block retracted position when the bolt 56 is in the bolt retracted position. The seal block 12 is extended to the seal block extended position, when the astragal seal shoulder 16 is released from the bolt shoulder 58, the compression springs 18 forcing the seal block 12 into the seal block extended position, when the bolt 56 is in the bolt extended position. The astragal seal shoulder 16, thus, acts as a catch, which catches the bolt shoulder 58 when the bolt 56 is retracted to the bolt retracted position, and is released from the bolt shoulder 58 when the bolt 56 is extended to the bolt extended position.

The self positioning astragal seal 10 automatically and independently adjusts itself to fit snugly and fill any gaps between bottom 60 of the astragal 30 and the sill 46 of the door frame 48, when the bolt 56 is in the bolt extended position, thus, preventing unwanted drafts between bottom 74 of the seal block 12 and the sill 46 of the door frame 48, the compression springs 18 forcing the seal block 12 opposingly away from the bottom 60 of the astragal 30 and forcing the end seal 20, which is affixed to the bottom 74 of the seal block 12, to abut the sill 46 of the door frame 48.

The seal block 12 has base 78, face plate 80, and guide block 82, which is adjacent the inactive door edge 42, when the self positioning astragal seal 10 and the astragal are installed on the inactive door 44 and the seal block 12 is in the retracted position, the face plate 80 and the guide block 82 being substantially perpendicular to the base 78, and substantially parallel one to the other.

The seal block 12 has substantially “T” shaped member 84 integral with the guide block 82 and compression spring guide holders 86, which hold the compression springs 18 in place, the compression springs 18 being mounted about the compression spring holders 86, with bottom ends 88 of the compression springs 18 abutting top 90 of the base 78. The seal block 12 has barrel 92 integral with the guide block 82, the barrel 92 having the substantially centrally disposed hole 14 therethrough to the bottom 74 of the seal block 12, the bolt 56 slidable therethrough the substantially centrally disposed hole 14, and the seal block 12 slidable about the bolt 56. The barrel 92 has extension 94, which is integral with the barrel 92, having arcuate interior 96, which is substantially collinear with the interior of the barrel 92, and extension 98 having the shoulder 16 and arcuate interior 100. The substantially “T” shaped member 84 has T top portion 102, which has arcuate interior 104, angled edges 105, and shoulder 106. The face plate 80 has reinforcements 108 having stops 110. The guide block 82 has edge stops 112 and reinforcements 114 having stops 116. The compression spring holders 86 have splines for reinforcement.

The elongated guide 52 of the astragal 30 has recesses 130, which have extension stops 132 and retraction stops 134 at opposing ends thereof, and substantially planar opposing side 136. The elongated guide 52 of the astragal 30 has substantially planar side portions 138 adjacent the recesses 130, which oppose the substantially planar opposing side 136, and sides 140, which are substantially perpendicular to the substantially planar side portions 138, the recesses 130, and the substantially planar opposing side 136. The elongated guide 52 also has opposing longitudinally disposed side channels 142. The substantially planar side portions 138 and the substantially planar opposing side 136 have threaded holes 144 and 146, respectively, therethrough, opposing one another, having set screws 148 therein, the set screws 148 extending across the longitudinally disposed side channels 142. The elongated guide 52 also has angled longitudinal edges 150 atop the substantially centrally disposed longitudinal channel 54 adjacent the recesses 130 and the substantially planar side portions 138.

The substantially “T” shaped member 84 and the face plate 80 of the seal block 12 matingly sandwich the recesses 130 and the substantially planar opposing side 136 of the astragal 30, respectively, therebetween, and retain the seal block 12 slidably mating about the elongated guide 52 between the seal block retracted position and the seal block extended position, and vice versa.

The compression springs 18 are mounted about the compression spring holders 86, with the bottom ends 88 of the compression springs 18 abutting the top 90 of the base 78 of the seal block 12 and top 152 of the compression springs 18 abutting the set screws 148 in the longitudinally disposed side channels 142 of the astragal 30. The compression springs 18 are held in the longitudinally disposed side channels 142 of the astragal 30 under compression, the extension stops 132 of the astragal 30 preventing the compression springs 18 from forcing the substantially “T” shaped member 84 out of the recesses 130.

The barrel 92 of the seal block 12 is matingly slidable about the bolt 56 of the astragal 30, and the bolt 56 is matingly slidable therethrough the substantially centrally disposed hole 14 of the barrel 92 of the seal block 12. The angled edges 105 of the substantially “T” shaped member 84 matingly abut the angled longitudinal edges 150 of the astragal 30. The angled edges 105 of the substantially “T” shaped member 84 and the barrel 92 of the guide block 82 guide the seal block 12 collinearly with the angled longitudinal edges 150 of the astragal 30 and the substantially centrally disposed longitudinal channel 54, the bolt 56 being substantially aligned with the substantially centrally disposed longitudinal channel 54.

The extension stops 132 and the retraction stops 134 limit the extent of travel of the substantially “T” shaped member 84, and, thus, limit the extent of travel of the seal block 12 and the end seal 20 from the seal block extended position to the seal block retracted position, respectively, the compression springs 18 forcing the seal block 12 into the extended position, other than when the seal block 12 is retracted. The seal block 12 is retracted to the retracted position, the astragal seal shoulder 16 catching and abutting the bolt shoulder 58, and holding the seal block 12 in the seal block retracted position, when the bolt 56 is in the bolt retracted position. The seal block 12 is extended to the seal block extended position, when the astragal seal shoulder 16 is released from the bolt shoulder 58, the compression springs 18 forcing the seal block 12 into the seal block extended position, when the bolt 56 is in the bolt extended position. The end seal 20 has substantially centrally disposed hole 154 therethrough, which is substantially aligned collinearly with the substantially centrally disposed hole 14 of the seal block 12, which allows the end seal 20 to slide about the bolt 56, and vice versa. The self positioning astragal seal 10 has face seal 156, which is affixed to exterior side 158 of the face plate 78 of the seal block 20 and abuts edge 160 of active door 162, when the active door 162 is closed abuttingly against the inactive door 44, thus, preventing unwanted drafts between the self positioning astragal seal 10 and the edge 160 of the active door 162. The astragal 30 also has edge seal 163.

The self positioning astragal seal 10 may be used with the astragal 30 adjacent the sill 46 and/or header 164 of the door frame 48, and may be used with the inactive door 44 and/or the active door 162. Typical installations, however, have the astragal 30 mounted to the edge 42 of the inactive door 44, and the self positioning position astragal end seal 20 mounted to the astragal 30 adjacent the sill 46.

The self positioning astragal seal 10 may be used with a variety of astragals but is preferably used with the astragal 30 shown in the accompanying figures. Other astragals may be modified to suit the needs of particular applications.

The end seal 20 and the face seal 156 may have adhesives covered by peel off adhesive strips 166 and 168, respectively, the end seal 20 and the face seal 156 being fastened to the seal block 12 with the adhesives, upon removal of the adhesive strips 166 and 168, respectively.

The astragal 30 has astragal housing 180 having longitudinal channel 182, which has longitudinal retention guides 184, the elongated guide 52 inserted into the longitudinal channel 182 and held in the longitudinal channel 182 by the retention guides 184 and the set screws 148, and channel base 185, the set screws 148 locking the elongated guide 52 into the astragal housing 180. The astragal 30 also has lockset strike 186, deadbolt strike 188, and upper bolt 190 mounted to the longitudinal channel 182 of the astragal housing 180, the bolt 56 and the upper bolt 190 being used to lock the astragal 30, and, thus, the inactive door 44, which the astragal 30 is affixed to, to the sill 46 and the header 164, respectively, of the door frame 48. The upper bolt 190 may be used with the self positioning astragal seal 10 and/or alternatively the upper bolt 190 may use an alternative sealing means. Upper bolt assembly 191 having the upper bolt 190 is installed into the longitudinal channel 182 in substantially the same manner as the elongated guide 52. The active door 162 has lockset 192 and deadbolt 194, which are received by lockset strike 186, deadbolt strike 188, respectively, on the inactive door 44, for securing the active door 162 to the inactive door 134 when the active door 162 is closed abuttingly adjacent the inactive door 44. The astragal housing 180 has lockset cover plate 196 and deadbolt cover plate 198, which are mounted to the astragal housing 180, the lockset strike 186 and the deadbolt strike 188 being fastened to the lockset cover plate 196 and the deadbolt cover plate 198 with screws 199.

The astragal 30 has latching member 200, pull block 202, elongated connector 204, compression spring 206 about the elongated connector 204, and slide plate 208. The bolt 56 has lower portion 210, mid portion 212 adjacent the shoulder 58, the mid portion 212 having a smaller diameter than the diameter of the lower portion 210, and upper portion 214, the upper portion 214 of the bolt 56 having substantially the same diameter as the lower portion 210, and having a slot 216 therethrough and a hole 218 therethrough, the slot 216 and the hole 218 substantially perpendicular one to the other.

The elongated connector 204 has end pin 220, opposing hole 222, and pin 224 therebetween, the end pin 220 and the pin 224 substantially perpendicular to the plane of the elongated connector 204. The elongated connector 204 is sandwiched in the slot 216 of the upper portion 214 of the bolt 56, the hole 218 and the hole 222 aligned one with the other, the bolt 56 and the elongated connector 204 pinned one to the other with pin 226, the pin 226 therethrough the holes 222 and 218.

The pull block 202 has longitudinal tracks 228, retention tracks 230 and 232, and channels 234 and 236, the channels 234 between the longitudinal tracks 228 and the retention tracks 230, and the channels 236 between the longitudinal tracks 230 and the retention tracks 232. The pull block 202 is inserted into the longitudinal channel 182 of the astragal housing 180, the channels 234 and 236 being adjacent to the retention guides 184 of the astragal housing 180, the retention guides 184 slidably retaining the pull block 204 in the astragal housing 180. The pull block 202 has substantially centrally disposed notch 238 at base 240 of the pull block 202, notch 242 adjacent and substantially perpendicular to the substantially centrally disposed notch 238, and bearing notches 244. The substantially centrally disposed notch 238 is adjacent to and surrounds the elongated connector 204 adjacent the end pin 220 of the elongated connector 204; and sides 246 of the notch 242 surround and abut the end pin 220, thus, pinning the elongated connector 204 to the pull block 202 one to the other. The pull block 202 also has lever arm receiving hole 248.

The latching member 200 has lever arm 250, which has trunnions 252 protruding therefrom, spring tail 254, and latching dog 256.

The slide plate 208 has retraction hole 260, extension hole 262, notches 264, which form end tabs 266, and projecting tabs 268, which form projecting notch 270 therebetween, the projecting notch 270 for matingly slidably receiving the elongated connector 204 therebetween.

The elongated guide 52 is locked into the astragal housing 180 with the set screws 148. The elongated guide 52 has notched recesses 280 opposing the recesses 130, the notched recesses 280 matingly receiving the end tabs 266 of the slide plate 208 therein, and adjacent ends 282, the notches 264 of the slide plate 208 matingly receiving the ends 282 of the elongated guide 52 therein, the slide plate 208 being sandwiched and locked between the elongated guide 52 and the channel base 185 of the astragal housing 180. The projecting notch 270 of the slide plate 208 slidably guides the elongated connector 204, which is located in the projecting notch 270, substantially collinear with the center line of the elongated guide 52. The latching member 200 is sandwiched between the pull block 202 and the slide plate 208, with the trunnions 252 in the bearing notches 244 of the pull block 202 and the lever arm 250 extending through the lever arm receiving hole 248 of the pull block 202, thus facilitating operator control.

The retraction hole 260 and the extension hole 262 of the latching member 200 matingly receive the latching dog 256 of the latching member 200 therein.

The latching member 200 may be retracted to a latching member retracted position, when the lever arm 250 of the pull block 202 is depressed and pushed in the direction of pull block arrow marking 284, which pulls the elongated connector 204 in the direction of the pull block arrow marking 284, pulls the bolt 56 into the bolt retracted position, pulls the seal block 12 into the seal block retracted position, compresses the compression springs 18, and compresses the compression spring 206 between the pin 224 of the elongated connector 204 and the projecting tabs 268 of the slide plate 208. When the latching member 200 is retracted to the latching member retracted position, the spring tail 254 of the latching member 200 forces the latching dog 256 into the retraction hole 260 of the slide plate 208, thus, locking the bolt 56 into the bolt retracted position and locking the seal block 12 into the seal block retracted position.

The latching member 200 may be released into a latching member extended position from the latching member retracted position, when the lever arm 250 of the pull block 202 is depressed and released, releasing compression from the compression spring 206 between the pin 224 of the elongated connector 204 and the projecting tabs 268 of the slide plate 208, forcing the elongated connector 204 in the direction opposing the pull block arrow marking 284, forcing the bolt 56 into the bolt extended position, releasing compression on the compression springs 18, which forces the seal block 12 into the seal block extended position. When the latching member 200 is released, the latching member 200 snaps into latching member extended position, the latching dog 256 snaps into the extension hole 262 of the slide plate 208, the spring tail 254 of the latching member 200 forcing the latching dog 256 into the extension hole 262, thus, locking the bolt 56 into the bolt extended position with the seal block 12 in the seal block extended position, the seal block 12 automatically and independently self positioned with the end seal 20 abutting the sill 46 of the door frame 48. The latching member 200 may alternatively be pushed into the latch member extended position.

The substantially centrally disposed longitudinal channel 54 of the elongated guide 52 has arcuate sides 286 and arcuate base 288 to slidably and matingly accommodate the bolt 56, the lower portion 210 and the mid portion 212 of which are substantially cylindrical and have substantially the same diameter. The mid portion 212 of the bolt 56 is also substantially cylindrical, but has a smaller diameter than the diameter than that of the lower portion 210 and the upper portion 214.

The astragal housing 180 and the elongated guide 52 are preferably of metal, such as aluminum or steel, thermoplastics, thermosetting polymers, rubber, or other suitable material or combination thereof.

The seal block 12 and the latching member 200 are preferably injection molded from an engineered plastic resin that has properties to provide flexural strength, such as an acetal, although other suitable materials may be used. The end seal 20 and the face seal 156 are preferably of cellular material, such as closed cell neoprene sponge, although other suitable materials may be used.

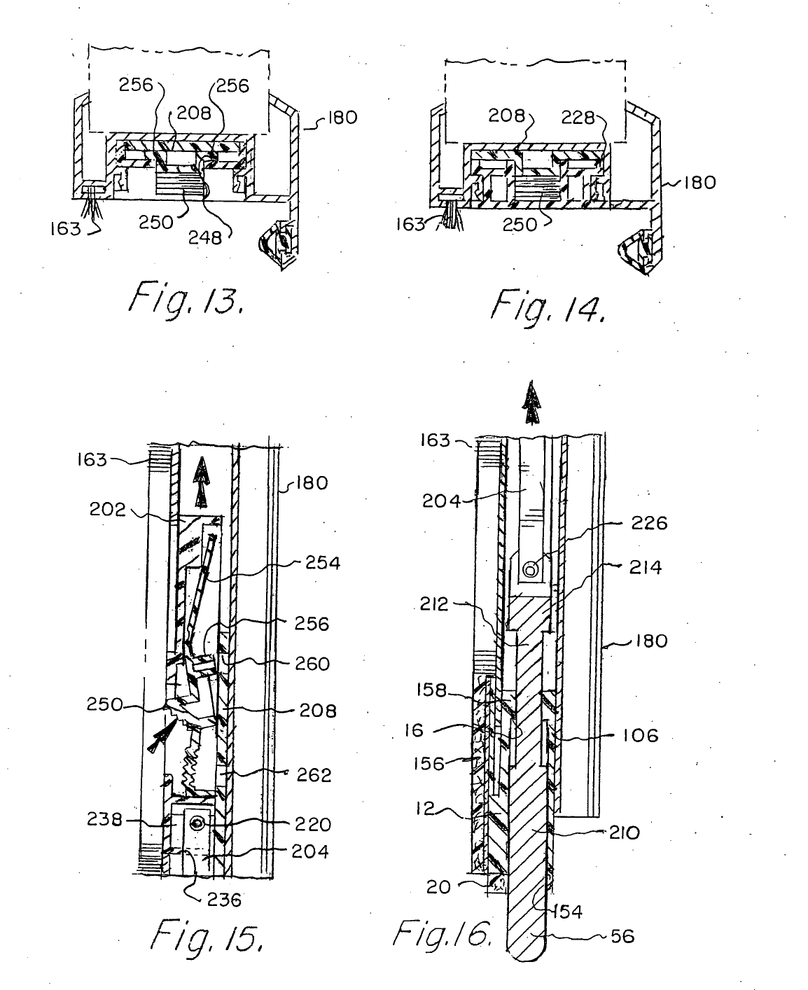

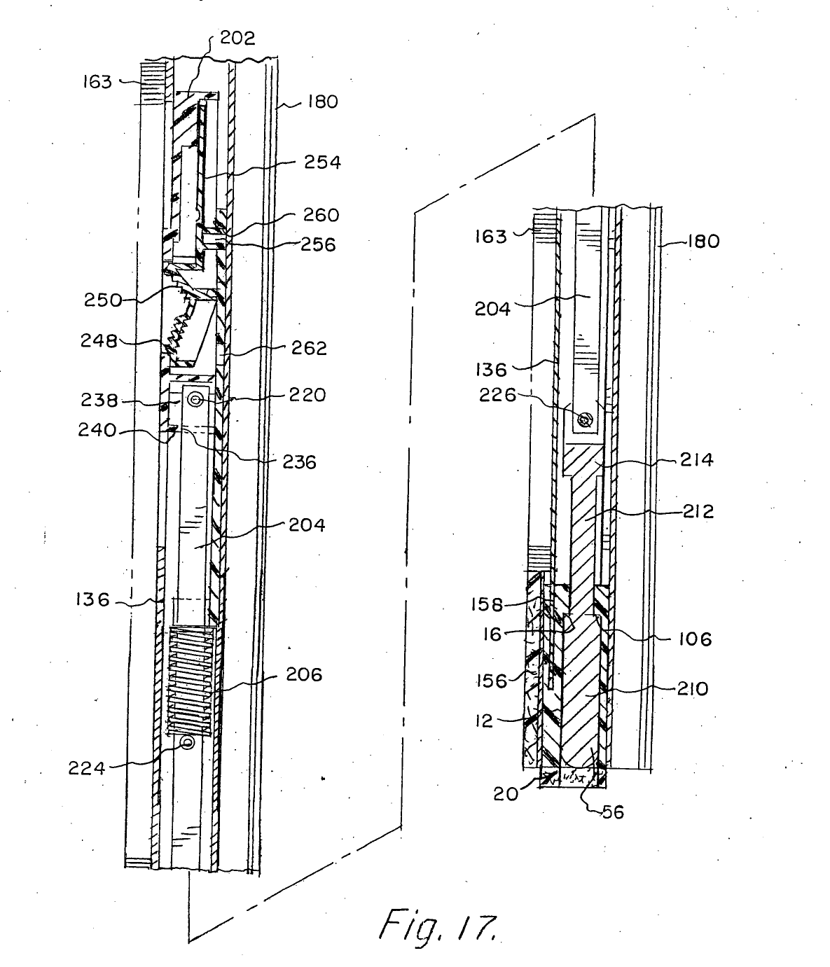

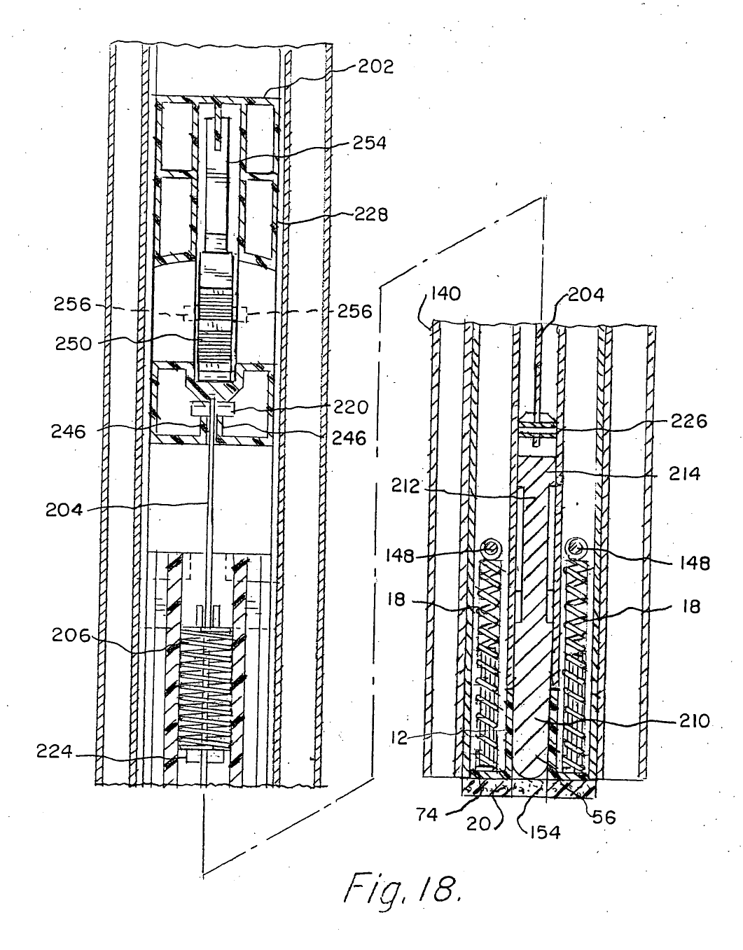

FIG. 15 shows the latching member 200 with the lever arm 250 depressed and the latching dog 256 ready to be moved to the retraction hole 260 of the slide plate 208, which is shown after being moved in FIGS. 17 and 18. The seal block 12 is also retracted along with the bolt 56, when the latching dog 256 is moved into the retraction hole 260, as shown in FIGS. 17 and 18.

The active door 162 and the inactive door 44 are “handed” as either right hand, in which the hinges of the active door 162 are on the right side of the active door 162 as viewed from the outside of the door frame 48 and left hand if the hinges of the active door 162 are on the left side of the door frame 48 as viewed from the outside of the door frame 48. The elongated guide 52 and the self positioning astragal seal 10 may easily be reversed from left hand to right hand, and vice versa, by merely loosening the set screws 148, removing the elongated guide 52 with the self positioning astragal seal 10 from the longitudinal channel 182 of the astragal housing 180, and installing the elongated guide 52 with the self positioning astragal seal 10 on the end of the astragal housing 180 opposing that from which it was removed, thus, converting the astragal 30 from one hand to the other.

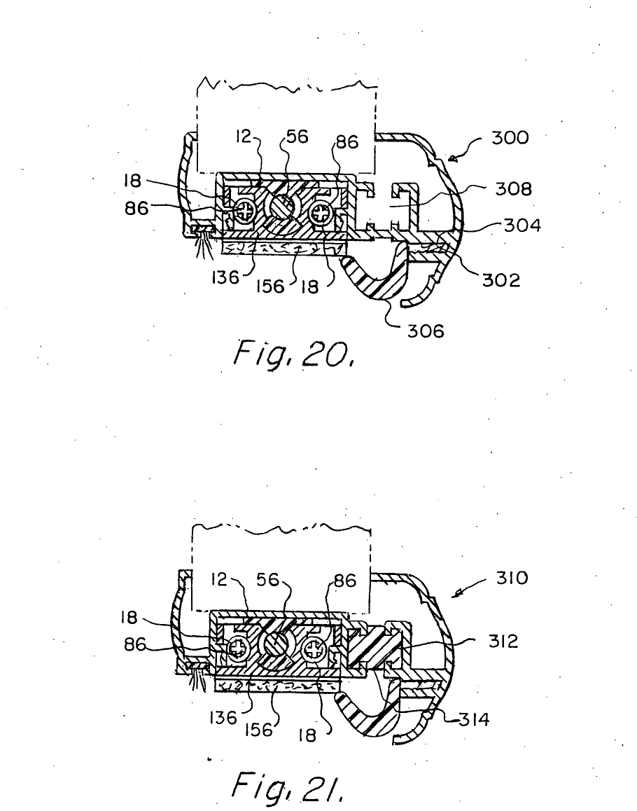

FIGS. 20-25 show alternate embodiments of astragals having astragal housings that the self positioning astragal 10 may be used with, although other suitable astragals having other suitable astragal housings may be used.

FIG. 20 shows an alternate embodiment of an astragal housing 300, which has a saw-tooth recess 302 to retain finned tail 304 of a typical wrapped foam type weather strip 306 for sealing. The astragal housing 300 also has cavity 308.

FIG. 21 shows an alternate embodiment of an astragal housing 310, which is substantially the same as the astragal housing 300, except that the astragal housing 310 has thermal break 312, for installations in climates that experience extremely cold weather, in which the astragal housing 310 is fabricated from an aluminum extrusion, or other suitable material having substantially the same properties, which would otherwise readily lose heat to the outside and result in condensation, and in some cases even the formation of ice. The thermal break 312 is created by filling cavity 308 of the astragal housing 300 with a polyurethane thermal break compound, after which it is de-bridged by milling slot 314, thus, separating outer and inner portions of the astragal housing 310 and preventing infiltration of the cold.

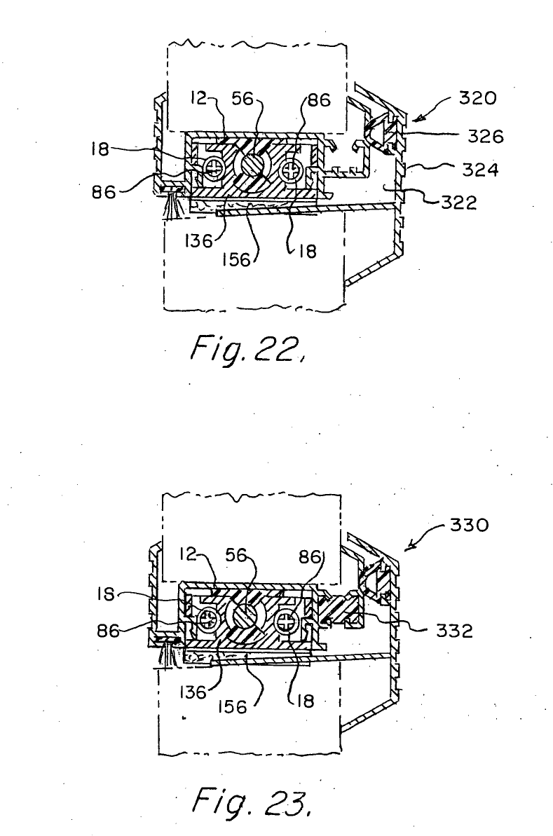

FIG. 22 shows an alternate embodiment of an astragal 320, which may be used for installation on a pair of outwsinging rather than inswinging doors, which has astragal housing 322, cover 324 that provides overlap, and outer seal 326, and is used on the active leaf of the pair of out swinging doors. Inner seal 328 is of greater reach as the beveled edge of the active door is reversed, creating a greater gap at its inner edge.

FIGS. 23 shows an alternate embodiment of an astragal 330, which may be used for installation on a pair of outwsinging rather than inswinging doors, which is substantially the same as the astragal housing 320, except that the astragal 330 has thermal break 332.

FIG. 24 shows an alternate embodiment of an astragal 340, which may be used for installation on a pair of outwsinging rather than inswinging doors, in which cover element 342 has saw-tooth recess 344 to accommodate finned tail 346 of a wrapped foam weather strip seal 348. Inner seal 349 is of greater reach as the beveled edge of the active door is reversed, creating a greater gap at the inner edge.

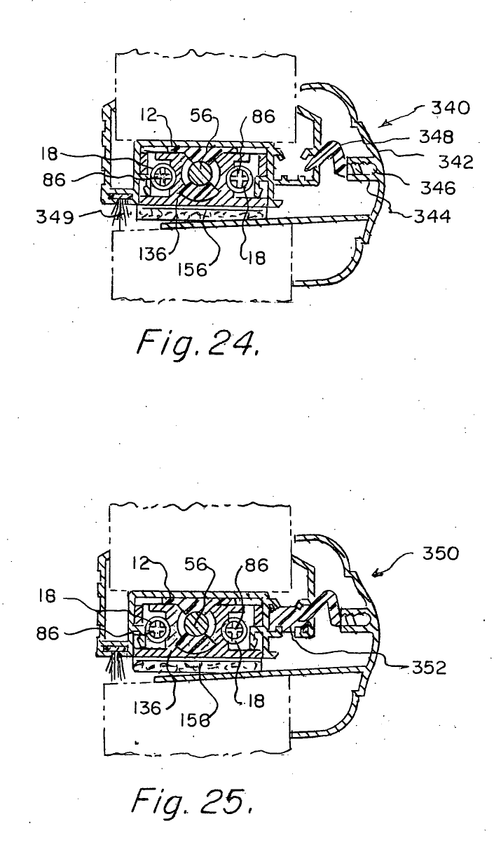

FIGS. 25 shows an alternate embodiment of an astragal 350, which may be used for installation on a pair of outwsinging rather than inswinging doors, which is substantially the same as the astragal housing 340, except that the astragal 350 has thermal break 352.

Although the present invention has been described in considerable detail with reference to certain preferred versions thereof, other versions are possible. Therefore, the spirit and scope of the appended claims should not be limited to the description of the preferred versions contained herein.

1. A self positioning astragal seal, for use with an astragal having a bolt having a bolt retracted position and a bolt extended position, comprising:
a seal block having a catch and a hole,
said bolt slidably disposed through said hole,
said catch catching a portion of said bolt and holding said seal block in a seal block retracted position when said bolt is in said bolt retracted position and releasing said seal block when said bolt is in said bolt extended position;
spring means forcing said seal block into a seal block extended position when said seal block is released.

2. The self positioning astragal seal according to claim 1, wherein said spring means comprises at least one compression spring.

3. The self positioning astragal seal according to claim 1, wherein said seal block catch comprises a shoulder.

4. The self positioning astragal seal according to claim 1, wherein said bolt portion comprises a shoulder.

5. The self positioning astragal seal according to claim 3, wherein said bolt portion comprises a shoulder,
said seal block shoulder catching said bolt shoulder and holding said seal block in said seal block retracted position when said bolt is in said bolt retracted position and releasing said seal block when said bolt is in said bolt extended position;

6. The self positioning astragal seal according to claim 1, wherein said seal block has an end seal.

7. The self positioning astragal seal according to claim 1, wherein said seal block has a face seal.

8. The self positioning astragal seal according to claim 6, wherein said seal block has a face seal.

9. The self positioning astragal seal according to claim 1, wherein said self positioning astragal seal is installed on said astragal.

10. The self positioning astragal seal according to claim 9, wherein said astragal is affixed to a door having a door frame, said door frame having a header and a sill.

11. The self positioning astragal seal according to claim 10, wherein said seal block has an end seal.

12. The self positioning astragal seal according to claim 11, wherein said end seal abuts said sill, when said seal block is in said seal block extended position.

13. The self positioning astragal seal according to claim 11, wherein said end seal abuts said header, when said seal block is in said seal block extended position.

14. The self positioning astragal seal according to claim 1, wherein said astragal is affixed to a door having a door frame, said door frame having a header and a sill, one said self positioning astragal is installed on said astragal adjacent said sill and another said self positioning astragal is installed on said astragal adjacent said header.

15. The self positioning astragal seal according to claim 6, wherein said astragal is affixed to a door having a door frame, said door frame having a header and a sill, one said self positioning astragal is installed on said astragal adjacent said sill and another said self positioning astragal is installed on said astragal adjacent said header;
said end seal of said self positioning astragal seal adjacent said sill abuts said sill, when said seal block is in said seal block extended position;
said end seal of said self positioning astragal seal adjacent said header abuts said header, when said seal block is in said seal block extended position;

16. The self positioning astragal seal according to claim 12, wherein said seal block extended position is automatically adjusting

17. The self positioning astragal seal according to claim 13, wherein said seal block extended position is automatically adjusting

18. The self positioning astragal seal according to claim 15, wherein said seal block extended position is automatically adjusting

19. The self positioning astragal seal according to claim 9, wherein said astragal has a bolt retraction stop.

20. The self positioning astragal seal according to claim 9, wherein said astragal has a bolt extension stop.

21. The self positioning astragal seal according to claim 9, wherein said astragal has a seal block retraction stop and a seal block extension stop;
said seal block retraction stop limiting the retracted extent of travel of said seal block to said seal block retracted position;
said seal block extension stop limiting the released extent of travel of said seal block when said seal block is released.

22. The self positioning astragal seal according to claim 9, wherein said seal block has a guide block adapted to guide said seal block between said seal block retracted position and a seal block released position when said seal block is released.

23. The self positioning astragal seal according to claim 1, wherein said seal block has a guide block adapted to mount said self positioning astragal seal to said astragal.

24. The self positioning astragal seal according to claim 23, wherein said guide block is adapted to guide said seal block between said seal block retracted position and a seal block released position when said seal block is released.

25. The self positioning astragal seal according to claim 23, wherein said spring means comprises at least one compression spring abutting at least one portion of said seal block and abutting at least one portion of said astragal.

26. The self positioning astragal seal according to claim 24, wherein said spring means comprises at least one compression spring abutting at least one portion of said seal block and abutting at least one portion of said astragal.

27. The self positioning astragal seal according to claim 1, wherein said seal block has a guide block adapted to slidably maintain said seal block about said astragal and guide said seal block between said seal block retracted position and a seal block released position when said seal block is released.

28. The self positioning astragal seal according to claim 1, wherein said astragal has an elongated guide and said seal block has a guide block adapted to slidably maintain said seal block about said elongated guide and guide said seal block between said seal block retracted position and a seal block released position when said seal block is released.

29. The self positioning astragal seal according to claim 28, wherein said spring means comprises at least one compression spring abutting at least one portion of said seal block and abutting at least one portion of said elongated guide.

30. The self positioning astragal seal according to claim 28, wherein said elongated guide has a substantially centrally disposed longitudinal channel and opposing longitudinal side channels;
said bolt slidable within said substantially centrally disposed longitudinal channel.

31. The self positioning astragal seal according to claim 30, wherein said side channels have stops therein and said spring means comprises compression springs;
said compression springs abutting said seal block and abutting said stops.

32. The self positioning astragal seal according to claim 31, wherein said guide block has compression spring guide holders, said compression springs mounted about said compression spring holders.

33. The self positioning astragal seal according to claim 28, wherein said elongated guide has a seal block retraction stop and a seal block extension stop;
said seal block retraction stop limiting the retracted extent of travel of said seal block to said seal block retracted position;
said seal block extension stop limiting the released extent of travel of said seal block when said seal block is released;

34. The self positioning astragal seal according to claim 33, wherein said guide block has a T shaped member adapted to guide said seal block between said seal block retracted position and said seal block released position when said seal block is released.

35. The self positioning astragal seal according to claim 1, wherein said astragal has spring means and a latching mechanism having a latch;
said latching mechanism retracting said bolt into said bolt retracted position and compressing said astragal spring means when said latch is retracted to a latch retracted position;
said latching mechanism releasing said bolt and said astragal spring means forcing said bolt into said bolt extended position and said latch into a latch released position when said latch is released.

36. The self positioning astragal seal according to claim 35, wherein said astragal spring means comprises a compression spring.

37. The self positioning astragal seal according to claim 9, wherein said astragal has spring means and a latching mechanism having a latch;
said latching mechanism retracting said bolt into said bolt retracted position and compressing said astragal spring means when said latch is retracted to a latch retracted position;
said latching mechanism releasing said bolt and said astragal spring means forcing said bolt into said bolt extended position and said latch into a latch released position when said latch is released.

38. The self positioning astragal seal according to claim 37, wherein said astragal spring means comprises a compression spring.

39. The self positioning astragal seal according to claim 28, wherein said astragal has spring means and a latching mechanism having a latch;
said latching mechanism retracting said bolt into said bolt retracted position and compressing said astragal spring means when said latch is retracted to a latch retracted position;
said latching mechanism releasing said bolt and said astragal spring means forcing said bolt into said bolt extended position and said latch into a latch released position when said latch is released.

40. The self positioning astragal seal according to claim 39, wherein said elongated guide has a substantially centrally disposed longitudinal channel and opposing longitudinal side channels;
said bolt slidable within said substantially centrally disposed longitudinal channel.

41. The self positioning astragal seal according to claim 40, wherein said side channels have stops therein and said self positioning astragal seal spring means comprises compression springs;
said self positioning astragal seal compression springs abutting said seal block and abutting said stops.

42. The self positioning astragal seal according to claim 40, wherein said astragal spring means comprises a compression spring and said substantially centrally disposed longitudinal channel has said astragal compression spring therein.

43. The self positioning astragal seal according to claim 41, wherein said astragal spring means comprises a compression spring and said substantially centrally disposed longitudinal channel has said astragal compression spring therein.

44. The self positioning astragal seal according to claim 1, wherein said seal block is molded.

45. The self positioning astragal seal according to claim 1, wherein said seal block of an acetal material.

46. The self positioning astragal seal according to claim 6, wherein said end seal is of cellular material.

47. The self positioning astragal seal according to claim 6, wherein said end seal is of closed cell neoprene sponge material.

48. The self positioning astragal seal according to claim 7, wherein said face seal is of cellular material.

49. The self positioning astragal seal according to claim 7, wherein said face seal is of closed cell neoprene sponge material.

50. The self positioning astragal seal according to claim 9, wherein said astragal is a locking astragal, which releasably locks said bolt into said bolt extended position.
